(19) United States
(12) Patent Application Publication
(10) Pub. No.: US 2013/0310554 A1
(43) Pub. Date: Nov. 21, 2013

(54) Aqueous Diphase Solvent System for Preparing High-Purity Polysaccharides

(71) Applicant: HONG KONG BAPTIST UNIVERSITY, Hong Kong (HK)

(72) Inventor: Quanbin HAN, Hong Kong (HK)

(73) Assignee: HONG KONG BAPTIST UNIVERSITY, Hong Kong (HK)

(21) Appl. No.: 13/831,877

(22) Filed: Mar. 15, 2013

Related U.S. Application Data
(60) Provisional application No. 61/648,620, filed on May 18, 2012.

(51) Int. Cl. C08B 37/00

(52) U.S. Cl. CPC C08B 37/0003
USPC 536/128

(57) ABSTRACT

The present invention provides an aqueous diphase solvent system for an one-step separation of high-purity polysaccharide from a mixture. In particular, the present invention provides method of purifying and isolating high molecular weight polysaccharides in plant with good homogeneity.

### CROSS-REFERENCE TO RELATED APPLICATIONS

The present application claims priority of U.S. provisional application No. 61/648,620 filed May 18, 2012, and which the disclosure is hereby incorporated by reference.

### FIELD OF INVENTION

The present invention is in the field of pharmaceuticals and chemical industries. In particular, this invention relates to an aqueous diphase solvent system for high-purity polysaccharides purification and isolation. The present invention also provides methods for purifying and isolating polysaccharide in natural products.

### BACKGROUND OF INVENTION

Polysaccharides exhibit a variety of biological activities such as anticancer, antiviral, immuno-stimulatory activities and have a long history of practical application in our daily life. A lot of botanical materials used in traditional medicine decoctions and Chinese soups are rich in polysaccharides, e.g. Ginseng, Radix Codonopsis, etc. Exploring the polysaccharides in herbs will help to uncover the secret of Chinese Medicine decoctions.

Because polysaccharides are water-soluble and macromolecules, they are hard-to-separate using the conventional separation methods that only work well in the separation of small molecules. Conventional separation methods based on solid separation materials have several disadvantages and limitations: (i) irreversible sample adsorption; (ii) risk of sample denaturation; (iii) peak tailing; and (iv) high consumption of solvents and columns/packing materials. Furthermore, the operation is very complicated and time consuming, and requires experienced and well trained hands. Conventional separation of the purified polysaccharide, which contains complicated operations, has poor repeatability and reproducibility.

Counter-current chromatography (CCC) shows significant advantages. This is an innovative separation technology based on the mechanism of solvent partition. Different compounds have varied distribution pattern in a diphase solvent system, e.g. EtOAc/H2O, due to their different chemical structures and solubility. When the solvent partition is operated continuously, the difference in the distribution pattern will be enlarged more and more until some similar compounds are completely separated. The biggest difference between CCC and conventional chromatography is that both mobile phase and stationary phase of CCC are liquid. Therefore, this method avoids all the problems caused by the solid separation materials. In addition, it is easy-to-operate because it can realize the one-step isolation of target compound from the crude extract. CCC has been popularly and widely applied in separation and purification of various natural products. It succeeds in preparation of some hard-to-separate chemical groups, like saponins, tannins, alkaloids, and even epimers. It shows great potential to simplify the separation of polysaccharides.

The CCC separation depends on the target compound's distribution pattern in the diphase solvent system. Therefore, the selection of a proper diphase solvent system is the most important step. This is the right problem of the CCC separation of polysaccharides. The aqueous diphase system (ATPS) has been used in the CCC separation of proteins and proteins have many chemical properties similar with those of polysaccharides.

Actually, four reports about CCC's application in separation of polysaccharide have been published: 1) “Countercurrent chromatographic purification of polysaccharides from Achyranthes bidentata with an aqueous two-phase system using a cross-axis coil planet centrifuge” by Chao et al (2003) in J. Liquid Chromatogr. Related Technol. 26, 1895-1903; 2) “Isolation of a polysaccharide with anticancer activity from Auricularia polytricha using high-speed countercurrent chromatography with an aqueous two-phase system” by Song et al (2010) in Journal of Chromatography, A, 1217, 5930-5934; 3) “Separation and purification of Lentinan by preparative high speed counter current chromatography” by Jiang et al (2009) in Fenxi Huaxue, 37, 412-416; 4) “Method for extracting and purifying phellinus linteus polysaccharide by high-speed countercurrent chromatography and ultrasound assistance” by Sun et al (2008) in Faming Zhuanli Shenqing Gongkai Shuomingshu 2008, CN 101323648 A 20081217 CAN 150:105964 AN 2008:1508788.

However, all the reported CCC separation of polysaccharide is not satisfactory. Realized in the first and the forth reports was only the removal of non-saccharide from crude polysaccharide fraction. The polysaccharides themselves were not separated and none of a polysaccharide with high homogeneity was obtained. Although the second and the third reports stated that polysaccharides with high homogeneity were obtained, the results were very questionable. It is well known that polysaccharides are not soluble in 80% ethanol at all. As the samples that were separated in these two reports could be examined by TLC on silica gel using n-butanol-ethanol-water (5:3:2) as the mobile phase, these isolates could not be polysaccharides. Furthermore, all these reports failed to simplify the separation procedure, since they all used crude polysaccharide fraction as the starting sample and remained these poorly-reproducible and complicated operations like precipitation with ethanol, deproteination with Sevag method, and dialysis, prior to CCC separation. And the present method using a PEG diphase solvent system that comprises the salt MgSO₄ is different from that used in all these reports.

U.S. Pat. No. 5,078,886 disclosed an application of PEG related diphase solvent systems in the separation of optical isomer mixtures or related organic molecules which have low solubility in water. No efficient solvent system for separation of polysaccharides is disclosed.

Accordingly, there is a need for a system which enables purification of polysaccharides which cannot be purified by existing system and isolation thereof.

Citation or identification of any reference in this section or any other section of this application shall not be construed as an admission that such reference is available as prior art for the present application.

### SUMMARY OF INVENTION

The objective of the present invention is to provide an aqueous diphase solvent system comprising PEG and MgSO₄ for use to purify and isolate high-purity polysaccharides. Another objective of the present invention provides a method for purifying and isolating polysaccharides in natural product comprising dissolving the natural product in the aqueous diphase solvent system and isolating polysaccharides by counter-current chromatography or liquid-to-liquid separation.

Those skilled in the art will appreciate that the invention described herein is susceptible to variations and modifications other than those specifically described.

The invention includes all such variation and modifications. The invention also includes all of the steps and features referred to or indicated in the specification, individually or collectively and any and all combinations or any two or more of the steps or features.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

Other definitions for selected terms used herein may be found within the detailed description of the invention and apply throughout. Unless otherwise defined, all other technical terms used herein have the same meaning as commonly understood to one of ordinary skill in the art to which the invention belongs.

Other aspects and advantages of the invention will be apparent to those skilled in the art from a review of the ensuing description.

### BRIEF DESCRIPTION OF DRAWINGS

The above and other objects and features of the present invention will become apparent from the following description of the invention, when taken in conjunction with the accompanying drawings, in which:

FIG. 1 shows a high speed countercurrent chromatography (HSCCC) analysis of water extract of Radix Astragali using the present diphase solvent system;

FIGS. 2 shows the GPC (Gel Permeation Chromatography) analysis of fraction A (FIG. 2A) and fraction B (FIG. 2C) isolated using the present diphase solvent system and HSCCC as well as the purified polysaccharide RAP-1 (FIG. 2B) using conventional methods.

### DETAILED DESCRIPTION OF INVENTION

The present invention provides an aqueous diphase solvent system comprising polyethylene glycol (PEG) and MgSO₄ for use to purify and isolate high-purity polysaccharides. In one embodiment, the PEG and MgSO₄ are in a ratio of 2 to 3:3 to 2. In another embodiment, the present diphase solvent system comprises 12-18% w/v PEG and 12-18% w/v MgSO₄. U.S. Pat. No. 5,078,886 describes various forms of PEG useful for the present invention and disclosure thereof is incorporated herein by reference in its entirety. In one embodiment, the molecular weight of PEG of the present invention is 1,000 to 3,400. The aqueous diphase solvent system according to the present invention is useful to purify polysaccharides which cannot be purified by conventional methods. In particular, the present solvent system is useful to purify large molecular weight polysaccharides in natural products. In one embodiment, the natural product is plant. The term “natural product” as used herein refers to any substances produced by a living organism, such as animals, plants and microorganisms.

The present invention also provides a method for purifying and isolating polysaccharides in a mixture comprising dissolving the mixture in an aqueous diphase solvent and separating polysaccharides by means of solvent extraction. Means of solvent extraction that is suitable to use in combination with the present diphase solvent system are large scale commercial separation methods, includes but are not limited to solvent partition, counter-current distribution, cross-current extraction, counter-current extraction, counter-current chromatography or liquid-to-liquid separation.

Extraction of Radix Astragali by PEG/MgSO₄ aqueous diphase solvent

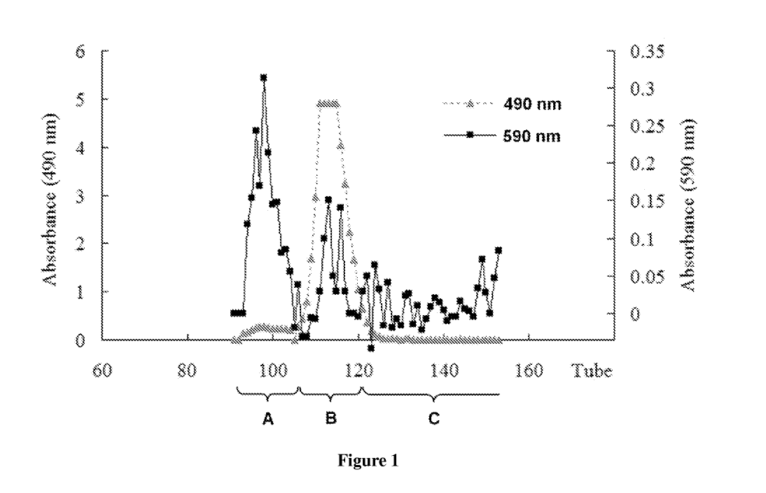

Plant Radix Astragali is subject to water extraction with boiling water. Solution is filtered and concentrated to obtain a water extract of Radix Astragali (RA). Water extract of RA is dissolved in the subject diphase solvent of 12% w/v PEG 1000 and 16% w/v MgSO₄. The CCC column is filled with the stationary phase (upper layer) commonly used in the art, then the column is rotated in “forward” direction at a speed of 500 rpm or above. After that, the solution of RA extract and present diphase solvent is injected into the column as the lower phase (mobile phase) in a “head to tail” mode at a flow rate of 0.8 mL/min or above. The effluent is collected with a fraction collector every 10 minute and examined using phenol-sulfuric acid at 490 nm and using Bradford method at 590 nm (FIG. 1). The fractions are combined according to the elution profile, then dialyzed (molecular weight cut-off 3500) and freeze dried.

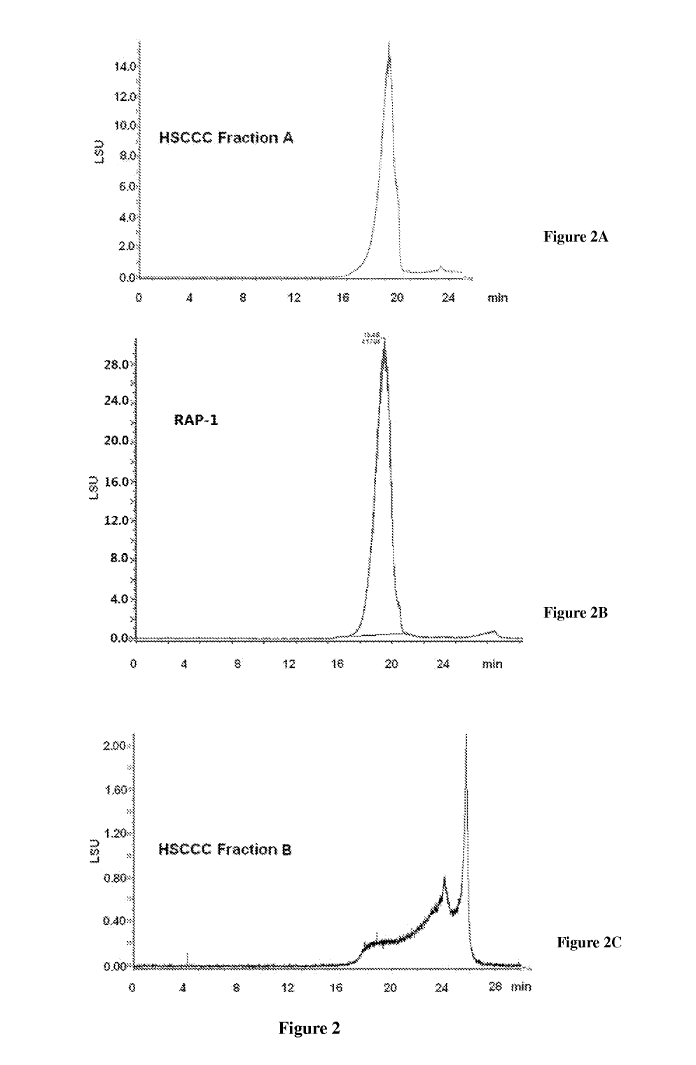

Retention time of fractions of RA obtained using the present invention is compared with fractions of RA obtained using conventional method. FIGS. 2 demonstrates that fractions A and B (FIGS. 2A and 2C) obtained from the present invention have similar retention time with RAP-1 (FIG. 2B) (the purified polysaccharide from Radix Astragali using conventional methods) in gel permeation chromatography (GPC), an HPLC analysis for macromolecules. Good homogenicity of polysaccharides purified using the present invention is demonstrated.

The present invention is not to be limited in scope by any of the specific embodiments described herein. The following embodiments are presented for exemplification only.

### INDUSTRIAL APPLICABILITY

The present invention is in the field of pharmaceuticals and chemical industries. In particular, this invention relates to a new aqueous diphase solvent system for purifying and isolating high-purity polysaccharides which cannot be done by conventional methods. This invention also can be used for preparation, purification and isolation of polysaccharide in natural products using counter-current chromatography or liquid-to-liquid separation. This solvent system succeeded in one-step separation of high-purity polysaccharide from the plant water extract. The isolates from the present invention demonstrates good homogeneity in GPC examination.

If desired, the different functions discussed herein may be performed in a different order and/or concurrently with each other. Furthermore, if desired, one or more of the above-described functions may be optional or may be combined.

While the foregoing invention has been described with respect to various embodiments and examples, it is understood that other embodiments are within the scope of the present invention as expressed in the following claims and their equivalents. Moreover, the above specific examples are to be construed as merely illustrative, and not limitative of the reminder of the disclosure in any way whatsoever. Without further elaboration, it is believed that one skilled in the art can, based on the description herein, utilize the present invention to its fullest extend. All publications recited herein are hereby incorporated by reference in their entirety.

What we claim:

1. A method for purifying and isolating polysaccharide from a natural product comprising preparing an aqueous diphase solvent system comprising 12-18% w/v PEG and 12-18% w/v MgSO₄,
mixing said aqueous diphase solvent system with said natural product to be separated to form a second mixture; and
separating the second mixture by means of solvent separation, wherein molecular weight of the PEG ranges from 1,000-3,400 and ratio of PEG to MgSO₄ is 2 to 3:3 to 2.

2. The method of claim 1 wherein the means of solvent separation is selected from the group consisting of solvent partition, counter-current distribution, cross-current extraction, counter-current extraction, counter-current chromatography or liquid-to-liquid separation.

3. The method of claim 1, wherein the natural product is a herb.

4. The method of claim 1, further comprising preparing an extract of the natural product.

5. The method of claim 4, wherein the extract is water extract.
